(19) United States
(12) Patent Application Publication
(10) Pub. No.: US 2024/0221708 A1
(43) Pub. Date: Jul. 4, 2024

(54) Virtual musical instrument based on UWB chip identification

(71) Applicant: Bin Wen, You (CN)

(72) Inventor: Bin Wen, You (CN)

(21) Appl. No.: 18/604,511

(22) Filed: Mar. 14, 2024

(30) Foreign Application Priority Data
Mar. 17, 2023 (CN) 202320600050.8

(51) Int. Cl. G10H 1/32; G01S 13/02; G01S 13/62; G10H 7/00

(52) U.S. Cl. CPC G10H 1/32; G01S 13/0209; G01S 13/62; G10H 7/004; G10H 2220/185; G10H 2220/201; G10H 2240/211; G10H 2240/321

(57) ABSTRACT

The present disclosure discloses a virtual musical instrument based on Ultra-Wide Band (UWB) chip identification, including at least one motion capture component and a conversion component, wherein a UWB transmitting chip is arranged in the at least one motion capture component, and a motion trajectory of the motion capture component is captured through the UWB transmitting chip; a UWB receiving chip is arranged in the conversion component, and a signal of the UWB transmitting chip in the at least one motion capture component is received through the UWB receiving chip; and the virtual musical instrument further includes a sound output component wirelessly connected to the conversion component, wherein the sound output component receives a signal of the conversion component and sends out an audio of a corresponding region.

### TECHNICAL FIELD

The present disclosure relates to the technical field of musical instruments, and in particular, to a virtual musical instrument based on Ultra-Wide Band (UWB) chip identification.

### BACKGROUND

Among traditional musical instruments, drum sets have a large volume, high cost, and extremely high requirements for sites, and are inconvenient to move, which limits the popularization and application of the drum sets. With the development of an electronic technology, electronic drums have emerged, but the shortcomings of the traditional drum sets are not fundamentally solved. The traditional drum sets still have inherent defects. A virtual gaming drum set has emerged recently, but it needs to cooperate with an APP in a mobile phone. This drum set has poor compatibility, so that many cell phones cannot be connected to a drum stick, and users have to stare at screens of the cell phones for a long time, which is not conducive to the vision and physical health. Therefore, a virtual musical instrument based on UWB chip identification is provided to solve the problems of large space occupation and inconvenient movement of traditional musical instruments in the prior art.

### SUMMARY

One of the objectives of the present disclosure is to provide a virtual musical instrument based on Ultra-Wide-Band (UWB) chip identification, so as to solve the problems of large space occupation and inconvenient movement of traditional musical instruments in the prior art.

The virtual musical instrument based on the UWB chip identification according to the present disclosure can be implemented through the following technical solutions:

The virtual musical instrument based on the UWB chip identification includes at least one motion capture component and a conversion component, wherein a UWB transmitting chip is arranged in the at least one motion capture component, and a motion trajectory of the motion capture component is captured through the UWB transmitting chip; a UWB receiving chip is arranged in the conversion component, and a signal of the UWB transmitting chip in the at least one motion capture component is received through the UWB receiving chip; and the virtual musical instrument further includes a sound output component wirelessly connected to the conversion component, wherein the sound output component receives a signal of the conversion component and sends out an audio of a corresponding region.

In one of the implementations, each motion capture component further includes a shell component, a first main control board, a first battery, and a key mechanism; the shell component is a hollow cavity; the first main control board and the first battery are respectively fixedly arranged in the shell component; the UWB transmitting chip is arranged on the first main control board; and the key mechanism is arranged on the first main control board and penetrates through the shell component.

In one of the implementations, each motion capture component further includes a first charging interface and an LED lamp group; the first charging interface is arranged on the first main control board and penetrates through the shell component; and the LED lamp group is fixedly arranged in the shell component.

In one of the implementations, a plurality of windows are arranged at a position, corresponding to the LED lamp group, on the shell component.

In one of the implementations, the conversion component includes a conversion shell, a second main control board, a second battery, and an interface group; the conversion shell is a hollow cavity; the second main control board and the second battery are respectively fixedly arranged in the conversion shell; the UWB receiving chip is arranged on the second main control board; and the interface group is fixedly arranged on the second main control board and penetrates through the conversion shell.

In one of the implementations, a wireless communication module is further arranged on the second main control board.

In one of the implementations, the UWB receiving chip adopts DW1000 or DW3200.

In one of the implementations, the virtual musical instrument based on the UWB chip identification according to the present disclosure further includes at least one pedal component, and the at least one pedal component is wirelessly connected to the sound output component.

In one of the implementations, the pedal component includes a pedal shell, a third main control board, a third battery, a second charging interface, and a fixing member; the pedal shell is a hollow cavity; the third main control board and the third battery are respectively fixedly arranged in the pedal shell; the third main control board is provided with a wireless communication module and a sensing device; and the fixing member is movably arranged on the pedal shell.

In one of the implementations, the sound output component adopts a Bluetooth speaker.

Compared with the prior art, the virtual musical instrument based on the UWB chip identification according to the present disclosure has the beneficial effects:

The present disclosure provides the virtual musical instrument based on the UWB chip identification. The UWB chips are used to detect the motion trajectory of each motion capture component in real time. With the cooperation of the wireless communication module, the sound output component is controlled to send out the audio of the corresponding region, and the sound output component can also be controlled to send out the corresponding audio through the pedal component, which effectively achieves functions of the musical instrument and solves the problems of large space occupation and inconvenient movement of the traditional musical instrument in the prior art. The user to do practice at any time and anywhere, without any restrictions on the practice time. Meanwhile, the device is convenient for storage. A drum set can be played or practiced at any time and anywhere with only two motion capture components and one conversion component, as well as the sound output component, solving the problems of the portability and high cost of the traditional drum set or electronic drum.

### BRIEF DESCRIPTION OF THE DRAWINGS

For clearer descriptions of the technical solutions of the embodiments of the present disclosure, the accompanying drawings required to be used in the embodiments are briefly introduced below. It should be understood that the accompanying drawings below are only some embodiments of the present disclosure. Therefore, the embodiments shall not be regarded as limitations on the scope. A person of ordinary skill in the art can also derive other relevant drawings according to these drawings without creative work.

FIG. 1 is a schematic structural diagram of a virtual musical instrument based on UWB chip identification according to the present disclosure, including a motion capture component, a conversion component, and a pedal component;

FIG. 2 is a schematic diagram of an exploded structure of the motion capture component in the virtual musical instrument based on the UWB chip identification shown in FIG. 1 according to the present disclosure;

FIG. 3 is a schematic structural diagram of a conversion component in the virtual musical instrument based on the UWB chip identification shown in FIG. 1 according to the present disclosure;

FIG. 4 is a schematic diagram of an exploded structure of the conversion component shown in FIG. 3;

FIG. 5 is a schematic structural diagram of the pedal component in the virtual musical instrument based on the UWB chip identification shown in FIG. 1 according to the present disclosure; and

FIG. 6 is a schematic diagram of an exploded structure of the pedal component shown in FIG. 5.

### NUMERALS IN THE DRAWINGS

11: motion capture component; 111: shell component; 1111: upper shell; 1112: lower shell; 1113: gripping region; 1114: window; 112: first main control board; 113: UWB transmitting chip; 114: first battery; 115: key mechanism; 1151: key main body; 1152: key shell; 116: first charging interface; 117: LED lamp group; 12: conversion component; 121: conversion shell; 1211: conversion main shell; 1212: conversion cover plate; 122: second main control board; 123: second battery; 124: interface group; 13: sound output component; 14: pedal component; 141: pedal shell; 1411: pedal main shell; 1412: pedal cover plate; 142: third main control board; 143: third battery; 144: second charging interface; and 145: fixing member.

### DETAILED DESCRIPTION OF THE EMBODIMENTS

In order to make the objectives, technical solutions, and advantages of the embodiments of the present disclosure clearer, the technical solutions in the embodiments of the present disclosure are clearly described below with reference to the accompanying drawings in the embodiments of the present disclosure. Apparently, the described embodiments are merely some rather than all of the embodiments of the present disclosure. Assemblies of the embodiments of the present disclosure commonly described and shown in the accompanying drawings here may be arranged and designed in a variety of different configurations.

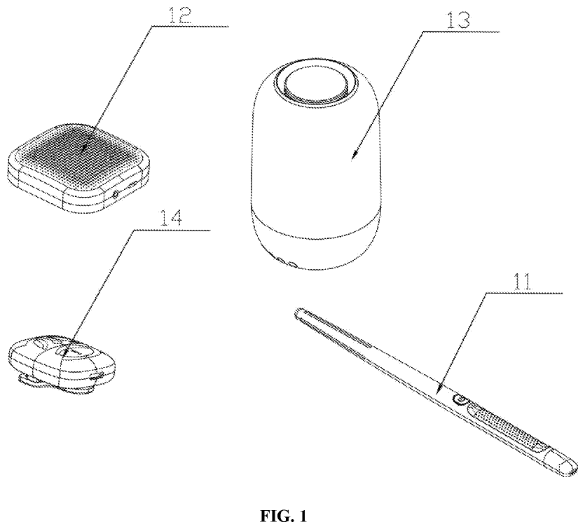

Referring to FIG. 1, a virtual musical instrument based on UWB chip identification according to the present disclosure mainly includes at least one motion capture component 11, a conversion component 12, a sound output component 13, and at least one pedal component 14. A UWB transmitting chip 113 is arranged in the at least one motion capture component 11, and a motion trajectory of the motion capture component 11 is captured through the UWB transmitting chip 113. A UWB receiving chip is arranged in the conversion component 12, and a signal of the UWB transmitting chip 113 in the at least one motion capture component 11 is received through the UWB receiving chip. The sound output component 13 is wirelessly connected to the conversion component 12. The UWB receiving chip controls, according to the motion trajectory of the at least one motion capture component 11, the sound output component 13 to send out an audio of a corresponding region. The at least one pedal component 14 is wirelessly connected to the sound output component 13. The sound output component 13 receives a signal of the at least one pedal component 14 and sends out a corresponding audio. In this embodiment, the virtual musical instrument adopts one motion capture component 11 and one pedal component 14. In other embodiments, the number of the motion capture components 11 maybe two, three, or more, and the specific number can be set according to an actual need of a user. The number of the pedal component 14 can also be two, three, or more, and the specific number can be set according to the actual need of the user.

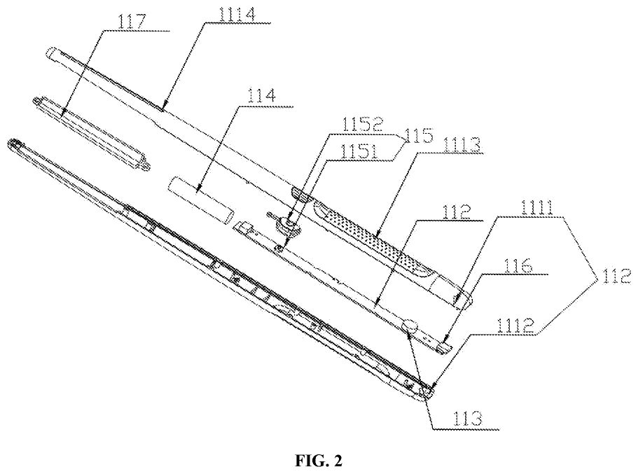

Referring to FIG. 1 and FIG. 2, in this embodiment, the motion capture component 11 is rod-shaped, which is a drum stick. The motion capture component 11 further includes a shell component 111, a first main control board 112, a first battery 114, a key mechanism 115, a first charging interface 116, and an LED lamp group 117. The shell component 111 is a hollow cavity. The first main control board 112, the first battery 114, and the LED lamp group 117 are respectively fixedly arranged in the shell component 111. The first main control board 112 is electrically connected to the UWB transmitting chip 113, the first battery 114, the key mechanism 115, the first charging interface 116, and the LED lamp group 117. Control technologies used are all the prior art, so specific control processes and product models used are not elaborated here. The UWB transmitting chip 113 is arranged on the first main control board 112 to capture the motion trajectory of the motion capture component 11. The key mechanism 115 and the first charging interface 116 are respectively arranged on the first main control board 112 and penetrate through the shell component 111. The key mechanism 115 is pressed to achieve origin positioning, which facilitates the cooperation between the UWB transmitting chip 113 and the UWB receiving chip for spatial region division, thereby effectively capturing the motion trajectory of the motion capture component 11. The first battery 114 is charged through the first charging interface 116.

Referring to FIG. 2, in this embodiment, the shell component 111 includes an upper shell 1111 and a lower shell 1112; the upper shell 1111 is arranged above the lower shell 1112; and the upper shell and the lower shell are connected to form a hollow cavity through a buckle structure or a screw structure. Gripping regions 1113 are arranged at corresponding positions on the upper shell 1111 and the lower shell 1112. In this embodiment, the gripping regions 1113 adopt convex points. This design is convenient for increasing friction forces between the hands of the user and the shell component 111. In other embodiments, the gripping regions 1113 can also adopt stripes. A plurality of windows 1114 are arranged at a position, corresponding to the LED lamp group 17, on the shell component 111, and light emitted by the LED lamp group 17 can be transmitted out through the plurality of windows 1114. In this embodiment, the key mechanism 115 includes a key main body 1151 and a key shell 1152. The key main body 1151 is arranged on the first main control board 112, and the key shell 1152 is arranged on the key main body 1151 and penetrates through the shell component 11.

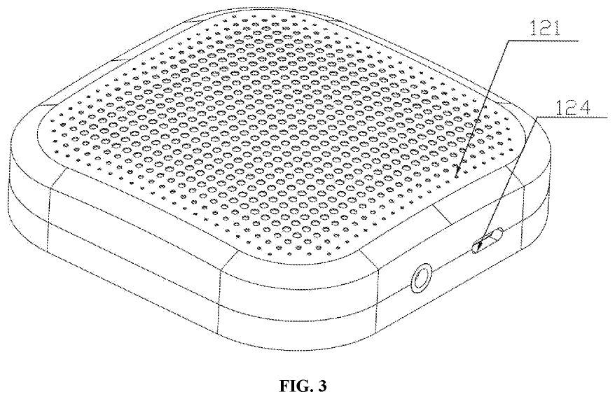

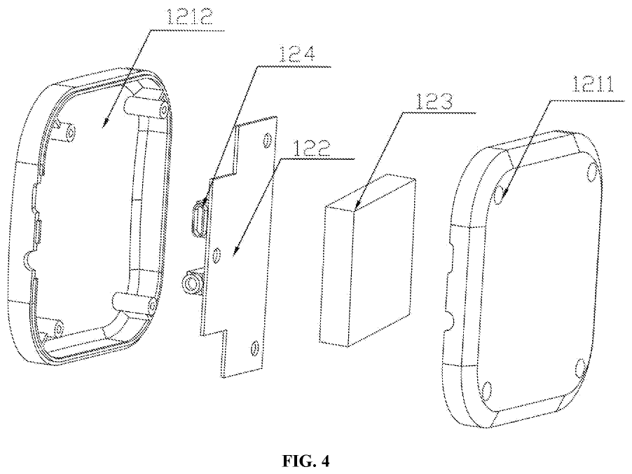

Referring to FIG. 1, FIG. 3, and FIG. 4, in this embodiment, the conversion component 12 includes a conversion shell 121, a second main control board 122, a second battery 123, and an interface group 124. The conversion shell 121 is a hollow cavity. The second main control board 122 and the second battery 123 are respectively fixedly arranged in the conversion shell 121, and the UWB receiving chip is arranged on the conversion shell. Specifically, the UWB receiving chip can adopt DW1000 or DW3200. In this embodiment, the UWB receiving chip is DW1000, which includes two receiving antennas. The signal of the UWB transmitting chip 113 is received through the two receiving antennas, thus determining a planar motion trajectory of the motion capture component 11. In other embodiments, the UWB receiving chip adopts DW3200, which includes three receiving antennas. The signal of the UWB transmitting chip 113 is received through the three receiving antennas, thus determining a three-dimensional motion trajectory of the motion capture component 11. The second main control board 122 is electrically connected to the second battery 123 and the interface group 124 respectively, and control technologies used are the prior art. Therefore, their specific control processes and product models used are not elaborated here. The interface group 124 is fixedly arranged on the second main control board 122 and penetrates through the conversion shell 121, and includes a charging interface and a connection interface. The charging interface charges the second battery 123, and the connection interface is connected to the sound output component in a wired manner. In this embodiment, a wireless communication module is arranged on the second main control board 122, and the second main control board is wirelessly connected to the sound output component 13 through the wireless communication module. Specifically, the wireless communication module adopts a Bluetooth wireless communication module.

Referring to FIG. 4, in this embodiment, the conversion shell 121 includes a conversion main shell 1211 and a conversion cover plate 1212; the conversion cover plate 1212 is arranged above the conversion main shell 1211; and the conversion cover plate and the conversion main shell are connected to form a hollow cavity through a buckle structure or a screw structure.

Referring to FIG. 1, in this embodiment, the sound output component 13 adopts a Bluetooth speaker, which is wirelessly connected to the conversion component 12 and the pedal component 14 through the Bluetooth wireless communication module. The sound output component is the prior art, so its specific structure will not be elaborated here, as long as the structure meets the requirements of the present disclosure.

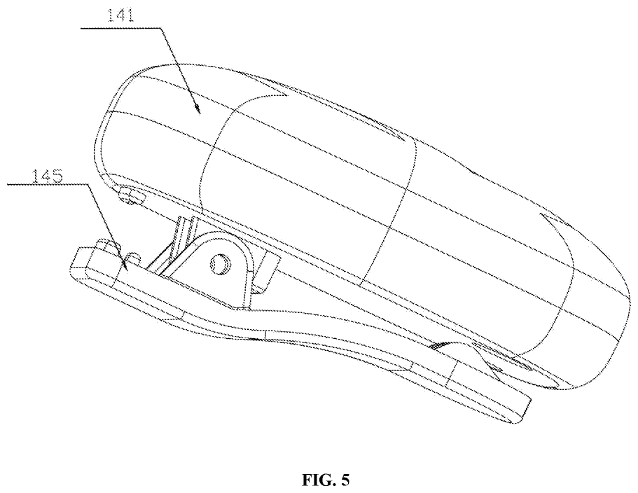

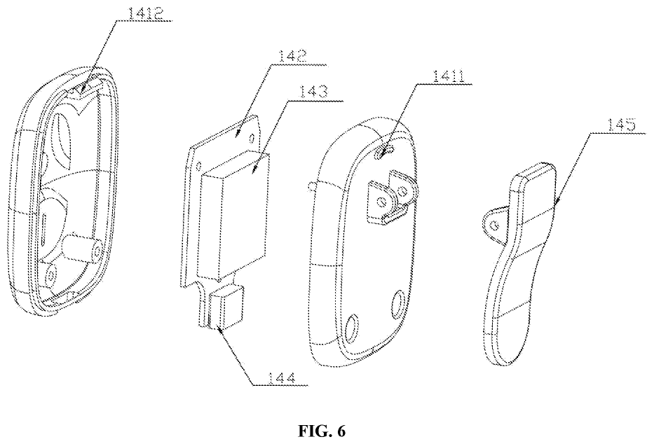

Referring to FIG. 1, FIG. 5, and FIG. 6, in this embodiment, the pedal component 14 includes a pedal shell 141, a third main control board 142, a third battery 143, a second charging interface 144, and a fixing member 145. The pedal shell 141 is a hollow cavity. The third main control board 142 and the third battery 143 are respectively fixedly arranged in the pedal shell 141. The third main control board 142 is electrically connected to the third battery 143 and the second charging interface 144, respectively. Control technologies used are all the prior, so specific control processes and product models used are not elaborated here. The third main control board 142 is provided with a wireless communication module, and is wirelessly connected to the sound output component 13 through the wireless communication module. Specifically, the wireless communication module adopts a Bluetooth wireless communication module. The third main control board 142 is further provided with a sensing device, and motions of the feet of the user are sensed through the sensing device, thereby controlling the sound output component 13 to send out a corresponding audio. The sensing device is also the prior art, so its specific implementation process will not be elaborated here. The second charging interface 144 charges the third battery 143. The fixing member 145 is movably arranged on the pedal shell 141, and the pedal component 14 is fixed on the feet of the user through the fixing member 145. Specifically, the fixing member 145 adopts a fixing clamp. The pedal component is clamped on the shoes of the user through the fixing clamp.

Referring to FIG. 6, in this embodiment, the pedal shell 141 includes a pedal main shell 1411 and a pedal cover plate 1412; the pedal cover plate 1412 is arranged above the pedal main shell 1411; and the pedal cover plate and the pedal main shell are connected to form a hollow cavity through a buckle structure or a screw structure.

It should be noted that according to the virtual musical instrument based on the UWB chip identification of the present disclosure, origins of both the UWB transmitting chip 113 and the UWB receiving chip are calibrated by pressing the key mechanism 115, and then the motion trajectory of the motion capture component 11 is monitored in real time through the UWB transmitting chip 113. The UWB receiving chip receives the signal of the UWB transmitting chip 113, By the wireless connection between the sound output component 13 and the conversion component 12, the UWB receiving chip controls, according to the motion trajectory of the at least one motion capture component 11, the sound output component 13 to send out the audio of the corresponding region. Meanwhile, the sensing device in the pedal component 14 monitors the motions of the feet of the user in real time. Through the wireless connection with the sound output component 13, the sound output component 13 receives the signal of the pedal component 14 and sends out the corresponding audio.

The foregoing embodiments merely express several implementations of the present disclosure. The descriptions thereof are relatively specific and detailed, but are not understood as limitations on the scope of the present disclosure. It should be pointed out that a person of ordinary skill in the art can also make several transformations and improvements without departing from the idea of the present disclosure. These transformations and improvements fall within the protection scope of the present disclosure. Therefore, the protection scope of the patent of the present disclosure shall be subject to the appended claims.

What is claimed is:

1. A virtual musical instrument based on Ultra-Wide Band (UWB) chip identification, comprising at least one motion capture component, wherein a UWB transmitting chip is arranged in each motion capture component;
a conversion component, wherein a UWB receiving chip is arranged in the conversion component; the UWB receiving chip comprises a plurality of receiving antennas; a signal of the UWB transmitting chip is received through the plurality of receiving antennas to determine a motion trajectory of the motion capture component;
a sound output component, wirelessly connected to the conversion component, wherein the sound output component receives a signal of the conversion component and sends out an audio in a corresponding region; and
at least one pedal component, wirelessly connected to the sound output component, wherein the sound output component receives a signal of the at least one pedal component and sends out a corresponding audio.

2. The virtual musical instrument based on the UWB chip identification according to claim 1, wherein each motion capture component is rod-shaped, which is a drum stick.

3. The virtual musical instrument based on the UWB chip identification according to claim 2, wherein the motion capture component further comprises a shell component, which is a hollow cavity; and a first main control board and a first battery, which are respectively fixedly arranged in the shell component, wherein the UWB transmitting chip is arranged on the first main control board; and a key mechanism, which is arranged on the first main control board and penetrates through the shell component; the key mechanism is pressed for origin positioning, so that the UWB transmitting chip cooperates with the UWB receiving chip for spatial region division to capture the motion trajectory of the motion capture component; and the first main control board is electrically connected to the UWB transmitting chip, the first battery, and the key mechanism, respectively.

4. The virtual musical instrument based on the UWB chip identification according to claim 3, wherein the motion capture component further comprises a light-emitting diode (LED) lamp group and a first charging interface; the first charging interface charges the first battery; and the first main control board is electrically connected to the LED lamp group and the first charging interface, respectively.

5. The virtual musical instrument based on the UWB chip identification according to claim 4, wherein the shell component comprises an upper shell and a lower shell; the upper shell is arranged above the lower shell; and the upper shell and the lower shell are connected to form a hollow cavity through a buckle structure or a screw structure.

6. The virtual musical instrument based on the UWB chip identification according to claim 5, wherein gripping regions are arranged at corresponding positions on the upper shell and the lower shell; and the gripping regions adopt convex points or stripes to increase friction forces between the hands of a user and the shell component.

7. The virtual musical instrument based on the UWB chip identification according to claim 5, wherein a plurality of windows are arranged at a position, corresponding to the LED lamp group, on the shell component, and light emitted by the LED lamp group is transmitted out of the shell component through the plurality of windows.

8. The virtual musical instrument based on the UWB chip identification according to claim 1, wherein the conversion component comprises a conversion shell, which is a hollow cavity; a second main control board and a second battery, which are respectively fixedly arranged in the conversion shell, wherein the UWB receiving chip is arranged on the second main control board; and an interface group, which is fixedly arranged on the second main control board and penetrates through the conversion shell; and the second main control board is electrically connected to the second battery and the interface group, respectively.

9. The virtual musical instrument based on the UWB chip identification according to claim 8, wherein the UWB receiving chip adopts DW1000, and comprises two receiving antennas; and the two receiving antennas cooperate to receive the signal of the UWB transmitting chip to determine a planar motion trajectory of the motion capture component.

10. The virtual musical instrument based on the UWB chip identification according to claim 8, wherein the UWB receiving chip adopts DW3200, and comprises three receiving antennas; and the three receiving antennas cooperate to receive the signal from the UWB transmitting chip to determine a three-dimensional motion trajectory of the motion capture component.

11. The virtual musical instrument based on the UWB chip identification according to claim 8, wherein the interface group comprises a charging interface and a connection interface; the charging interface charges the second battery; and the connection interface is connected to the sound output component in a wired manner.

12. The virtual musical instrument based on the UWB chip identification according to claim 8, wherein a wireless communication module is arranged on the second main control board, and the second main control board is wirelessly connected to the sound output component through the wireless communication module.

13. The virtual musical instrument based on the UWB chip identification according to claim 12, wherein the wireless communication module adopts a Bluetooth wireless communication module.

14. The virtual musical instrument based on the UWB chip identification according to claim 13, wherein the sound output component adopts a Bluetooth speaker, which is wirelessly connected to the conversion component and the pedal component through the Bluetooth wireless communication module.

15. The virtual musical instrument based on the UWB chip identification according to claim 8, wherein the conversion shell comprises a conversion main shell and a conversion cover plate; the conversion cover plate is arranged above the conversion main shell; and the conversion cover plate and the conversion main shell are connected to form a hollow cavity through a buckle structure or a screw structure.

16. The virtual musical instrument based on the UWB chip identification according to claim 1, wherein the pedal component comprises a pedal shell, which is a hollow cavity; and a third main control board and a third battery, which are respectively fixedly arranged in the pedal shell and are electrically connected to each other, wherein the third main control board is provided with a wireless communication module and is wirelessly connected to the sound output component through the wireless communication module; and the third main control board is further provided with a sensing device; and the sending device senses motions of the feet of the user and controls the sound output component to send out a corresponding audio.

17. The virtual musical instrument based on the UWB chip identification according to claim 16, wherein the pedal component further comprises a second charging interface and a fixing member; the second charging interface charges the third battery; the fixing member is movably arranged on the pedal shell; and the pedal component is fixed on the feet of the user through the fixing member.

18. The virtual musical instrument based on the UWB chip identification according to claim 17, wherein the fixing member adopts a fixing clamp, and the pedal component is clamped on the shoes of the user through the fixing clamp.

19. The virtual musical instrument based on the UWB chip identification according to claim 16, wherein the pedal shell comprises a pedal main shell and a pedal cover plate; the pedal cover plate is arranged above the pedal main shell; and the pedal cover plate and the pedal main shell are connected to form a hollow cavity through a buckle structure or a screw structure.

20. The virtual musical instrument based on the UWB chip identification according to claim 16, wherein the wireless communication module adopts a Bluetooth wireless communication module.
